(19) United States
(12) Patent Application Publication
(10) Pub. No.: US 2004/0188182 A1
(43) Pub. Date: Sep. 30, 2004

(54) NRG magic

(76) Inventors: Steve J. Walters, San Jose, CA (US); Frank P.J. Fletcher, Newark, CA (US); Jeffrey R. Riddell, Folsom, CA (US)

Correspondence Address: Jeffrey R. Riddell, 1145 Kingfisher Circle, Folsom, CA, 95630, US

(21) Appl. No.: 10/394,594

(22) Filed: Mar. 24, 2003

(51) Int. Cl. B66B 1/00

(52) U.S. Cl. 187/247

(57) ABSTRACT

NRG Magic is an energy saving device designed exclusively for Vertical Transportation, in particular, Elevators. Elevators are usually left in the operational mode 24/7. The elevator interior cab lights and ventilation fan remain on unnecessarily when the elevator is not in use, consuming valuable electrical energy. We refer to this time as “Idle Time”. Idle time can be experienced during regular working hours pending the foot traffic in the building and after hours and weekends for extended periods. It is the idle condition that we are concerned with. NRG Magic will turn off the lights and fan after a period of five minutes of idle time has elapsed and maintains that state until the elevator controller receives a floor call. At that time and prior to the elevator door opening, the lights and fan are restored allowing the passengers to enter and ride safely. The cycle continues.

### CROSS-REFERENCE TO RELATED DOCUMENTS

Cross-reference is made to “Disclosure Document No. 520408”.

Inventors:

1. Steve J. Walters, US Citizen, 1140 Keltner Ave., San Jose, Calif. 95117.

2. Frank P. J. Fletcher, US Citizen, 6090 G Joaquin Mueita, Newark, Calif. 94560.

3. Jeffrey R. Riddell, Australian Citizen, 1145 Kingfisher Circle, Folsom, Calif. 95630.

### REFERENCE TO SEQUENCE LISTING, A TABLE, OR A COMPUTER PROGRAM LISTING COMPACT DISC APPENDIX

Not Applicable.

### BACKGROUND OF THE INVENTION

NRG MAGIC is an Energy Saver for Elevators. It turns the elevator car interior lighting and ventilation fan off when the elevator is at rest. Elevators are designed, manufactured and installed to be completely available twenty four hours a day, seven days a week regardless whether the building is occupied or not. Providing power is being supplied to a building, every function of an elevator including the ventilation fan and interior car lighting is on and ready. NRG MAGIC is designed to turn off the interior car lighting and ventilation fan after a short period of non-activity has lapsed and immediately reactivate lighting and ventilation fan when a “Floor Call” is received by either the hallway call station button (located outside the elevator near the door) or car operating panel (inside the elevator car).

### BRIEF DESCRIPTION OF THE VIEW OF THE DRAWING

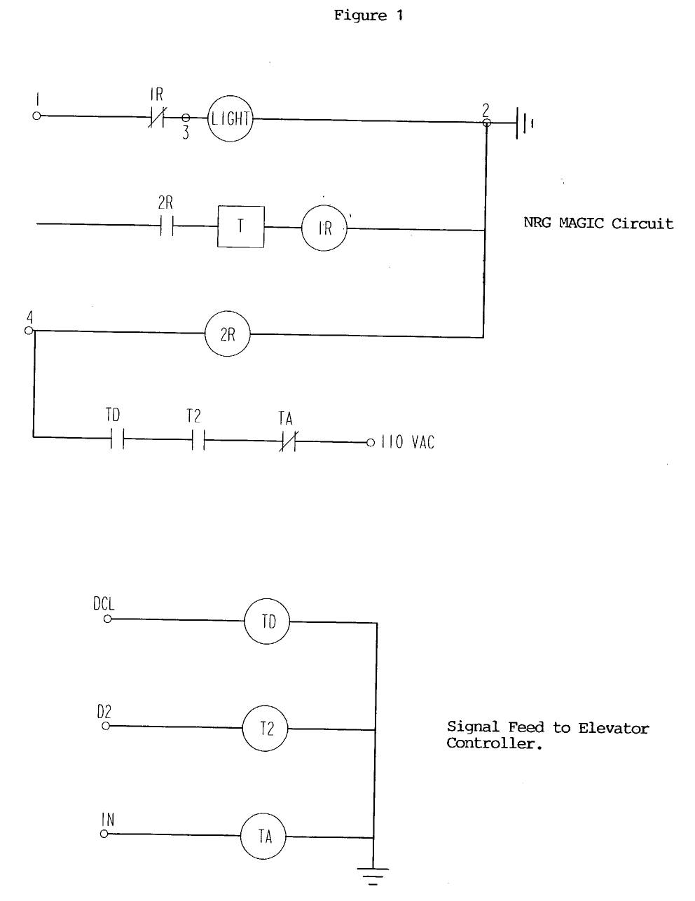

Drawing, FIG. 1 shows two views, electrical circuit and components of the NRG MAGIC itself and the signal feed to the Elevator Controller which controls all functions of the elevator.

### DETAILED DESCRIPTION OF THE INVENTION

NRG MAGIC is designed to turn off the interior car lighting and ventilation fan after the elevator has been sitting idle for five (5) minutes and reactivate the lights and fan as soon as the elevator receives a “Door Open” signal. The cycle is repeated continuously.

Emergency Lighting—Elevator Emergency Lighting, which is activated when electrical power is cut to the elevator, is NOT affected by NRG Magic. Emergency lighting will continue to operate as originally designed by the manufacturer of the elevator.

Entrapment—NRG MAGIC is designed to be “FAIL SAFE”. “Entrapment”, terminology used within the Elevator Industry when passengers are involved, to describe a malfunction of the elevator causing the elevator to cease operation regardless of the elevator car location. Example: Elevator stuck between floors containing passengers is an “Entrapment”. NRG MAGIC senses the malfunction, interior car lights and ventilation fan remain on.

Inventors:

4. Steve J. Walters, US Citizen, 1140 Keltner Ave., San Jose, Calif. 95117.

5. Frank P. J. Fletcher, US Citizen, 6090 G Joaquin Mueita, Newark, Calif. 94560.

6. Jeffrey R. Riddell, Australian Citizen, 1145 Kingfisher Circle, Folsom, Calif. 95630. 0008. ASME A17 204.7b2 National Code for Elevators states: Automatic operation of the lights may be furnished, but when provided, the operating circuit shall be arranged to turn off the lights only when the following conditions exist for not less than five (5) minutes.

a. The car is at the floor

b. The doors are closed.

c. There is no demand for service.

d. The car is on automatic operation.

Momentary interruption of any of the above conditions causes the car lights to turn on.

The above conditions are met with NRG MAGIC in the following ways;

1. Door zone, which will stop the timer if not at floor—T2.

2. Door close, which will stop timer as soon as door starts to move—TD.

3. Ina & Ind relays that change when car is taken off automatic.—TA.

With these inputs the five (5) minute timer will not turn the lights off if you are stuck between floors on any mode except auto. If you are stopped at the floor with the doors closed for more than five (5) minutes and the lights do go off, a small 120 volt neon bulb positioned behind the “Door Open” button located in the Elevator Car Operating Panel, is illuminated. Touching any button (car button, door open etc. located in the Car Operating Panel) the lights will go back on.

Features:

1. Fail Safe—In the event of a failure, lights and fan stay on.

2. Time Over-Ride/Test Button—allows elevator technician to periodically test lighting control.

3. Adaptable to most elevator systems—variable voltage operations.

4. Simple installation—approximately 1 hour.

5. Immediate energy savings.

6. Rapid return on investments.

Inventors:

7. Steve J. Walters, US Citizen, 1140 Keltner Ave., San Jose, Calif. 95117.

8. Frank P. J. Fletcher, US Citizen, 6090 G Joaquin Mueita, Newark, Calif. 94560.

9. Jeffrey R. Riddell, Australian Citizen, 1145 Kingfisher Circle, Folsom, Calif. 95630.

1. As previously stated, the vast majority of elevators are left in the “ON” position (power on) 24 hours of every day, ready to be used at any time. Passenger use is different for every elevator. It depends on the location of the building, type of business, number of floors, traffic in and out of the building, etc. However, most elevators will experience periods of inactivity throughout a 24 hour day even during regular working hours, but especially during after hours between 6 p.m. and 7 a.m. the following day. An unofficial and independent survey conducted by Stanford University of California, estimated a conservative twelve (12) hour period of inactivity for each elevator located on their campus. Based on the amount of power used to operate the lighting and fan of each elevator over a twelve hour inactive period for one year revealed an energy expense of $250.00 per elevator. Having approximately two hundred (200) elevators on campus, the University could experience savings of $50,000.00 (Fifty Thousand Dollars) annually in energy cost if the NRG Magic was installed on all their elevators.
We feel that Stanford's estimate of 12 hours inactivity per elevator is somewhat conservative and in many cases elevator inactivity where passenger traffic is low at any given time of the day could be as much as 20 hours. The actual period of inactivity where the lights and fan can be shut down as an energy saver is relevant to building traffic. A building fitting the 20 hour category would experience greater energy savings over the same period, thus making it a viable proposition even for the small building owner with a single elevator.
The return on investment to have NRG MAGIC installed by a qualified elevator technician would be approximately two years.
